(19) United States
(12) Patent Application Publication
(10) Pub. No.: US 2014/0138476 A1
(43) Pub. Date: May 22, 2014

(54) METHOD AND MEANS TO CONTROL THE POSITION AND ATTITUDE OF AN AIRBORNE VEHICLE AT VERY LOW VELOCITY

(71) Applicant: Per Olof Bystrom, Nyhamnslage (SE)

(72) Inventor: Per Olof Bystrom, Nyhamnslage (SE)

(73) Assignee: LAPCAD Engineering, Inc., San Diego, CA (US)

(21) Appl. No.: 13/682,979

(22) Filed: Nov. 21, 2012

(51) Int. Cl. B64C 27/10; B64C 29/00

(52) U.S. Cl. CPC B64C 27/10; B64C 29/00
USPC 244/17.13

(57) ABSTRACT

A vehicle equipped with two or more propulsion units, each, for example, consisting of engine with propeller, with their thrust principally directed vertically along a z-axis, such vehicle characterized by that each propulsion unit can be controlled by rotation around two axes mainly perpendicular to the z-axis and that the propulsion units are positioned some distance apart in the z-direction enabling such control of the attitude of the propulsion units to obtain:
a) lateral force without attendant moment around the center-of-gravity of the vehicle to control the lateral position of the vehicle, or
b) a moment around the center-of-gravity of the vehicle without attendant lateral force to control the lateral attitude of the vehicle, or
c) combination of (a) and (b)
   thereby to simplify the implementation of a system to control the position and attitude of the vehicle whether such control system is manipulated manually, automatically or in a combination thereof.

### BACKGROUND

Control of a vehicle during vertical takeoff, flight and landing usually requires special means. This is because conventional aircraft control surfaces are rendered ineffective at low or zero flight speed.

Several such special means already exist such as:

(1) Cyclic variation of the angle-of attack for the rotor on helicopter and tilt-rotor aircraft (V-22 Osprey, Agusta Westland AW609, U.S. Pat. No. 5,381,985 Wechsler et al.).

(2) Tail rotor on helicopter to control yaw

(3) Aerodynamic control surfaces in the airflow from propeller, rotor or fan (U.S. Pat. No. 5,758,844 Cummings, U.S. Pat. No. 6,343,768 Muldoon, U.S. Pat. No. 3,049,320 Fletcher)

(4) Small dedicated jets typically mounted at the front and rear of the fuselage and at the wingtips

(5) Pivoting or rotable exhaust nozzle on combustion engines (AV8B, F-35B)

(6) U.S. Pat. No. 8,256,704 to Lundgren, Vertical/Short Take-Off and Landing Aircraft discloses a thrust assembly comprising a pair of in-line counter-rotating fans and engines where the whole thrust assembly is rotatable about a lateral axis and a longitudinal axis to provide control of the location of the aircraft in the horizontal plane. Such rotation of the thrust assembly will create force components along the lateral axis and the longitudinal axis causing the aircraft to move in the fwd/aft and lateral direction. That concept requires that the Center of Gravity is located significantly below the axes of rotation of the thrust assembly. FIG. 6 illustrates an application of the U.S. Pat. No. 8,256,704.

The present invention is less dependant on the location of the Center of Gravity of the aircraft. While it can impose forces moving the aircraft in the horizontal plane, it can also control the attitude of the aircraft. FIGS. 7 through 9 and FIG. 14 shows both propulsion units aligned for steady state hover.

This invention describes a new method to achieve control without the use of the special means mentioned above.

Furthermore, this new method provides control of attitude and control of translation independent of each other for the pitch and roll axes.

### DETAILED DESCRIPTION

### List of Symbols

Ftx x-axis component of the thrust force
Fty y-axis component of the thrust force
Ftz z-axis component of the thrust force
Ftxe xe-axis component of the thrust force
Ftye ye-axis component of the thrust force
Ftze ze-axis component of the thrust force
Lt x-axis component of the thrust moment around the center-of-gravity (rolling moment)
Mt y-axis component of the thrust moment around the center-of-gravity (pitching moment)
Nt z-axis component of the thrust moment around the center-of-gravity (yawing moment)
n subscript denoting propulsion unit number
T thrust force
W weight force
X,Y,Z coordinate system fixed to the vehicle with the x- and y-axes principally horizontal and with the z-axis positive downward
Xe,Ye,Ze coordinate system parallel to the earth
Xt,Yt,Zt distances of thrust force to the center-of-gravity
δ rotation angle of a propulsion unit around its pivot
θ the Euler angle between the x-axis and the horizontal plane (pitch angle)
φ the Euler angle between the y-axis and the horizontal plane (roll angle)
Ψ the Euler angle between the projection of the x-axis on the horizontal plane and a reference orientation for example North (heading angle)
p subscript denoting pitch
r subscript denoting roll
1,2,3 subscripts denoting propulsion unit number

### BRIEF DESCRIPTION OF THE FIGURES

FIG. 1 shows the body x and z axes with pitch angle and two propulsion units

FIG. 2 shows the body y and z axes with roll angle and two propulsion units

FIG. 3 shows the body x and z axes with pitch angle and three propulsion units

FIG. 4 shows the body y and z axes with roll angle and three propulsion units

FIG. 5 shows the body x and y axes with yawing moment and three propulsion units

FIG. 6 shows an example with two in-line propulsion units

FIG. 7 shows the longitudinal and lateral axes on a vehicle with two in-line propulsion units

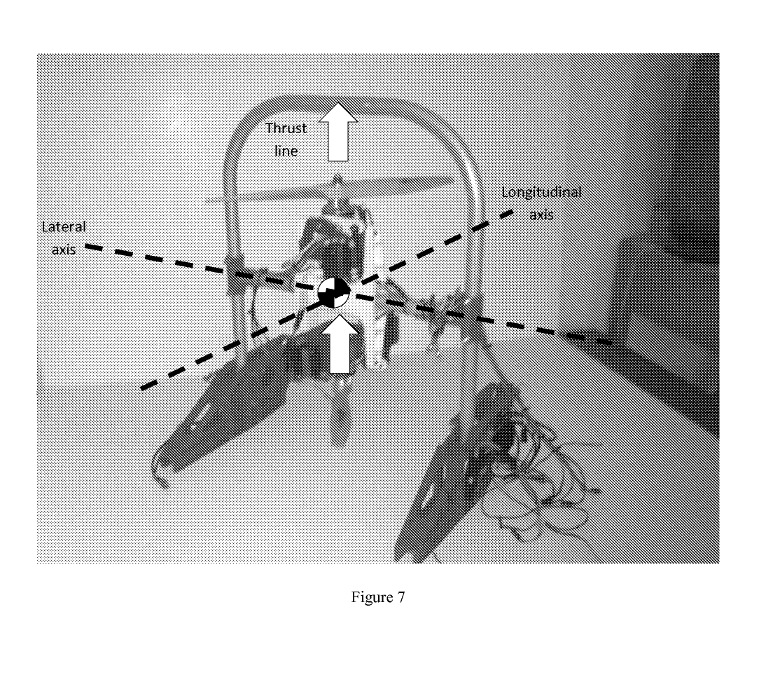

FIG. 8 shows the lateral axis on a vehicle with two in-line propulsion units

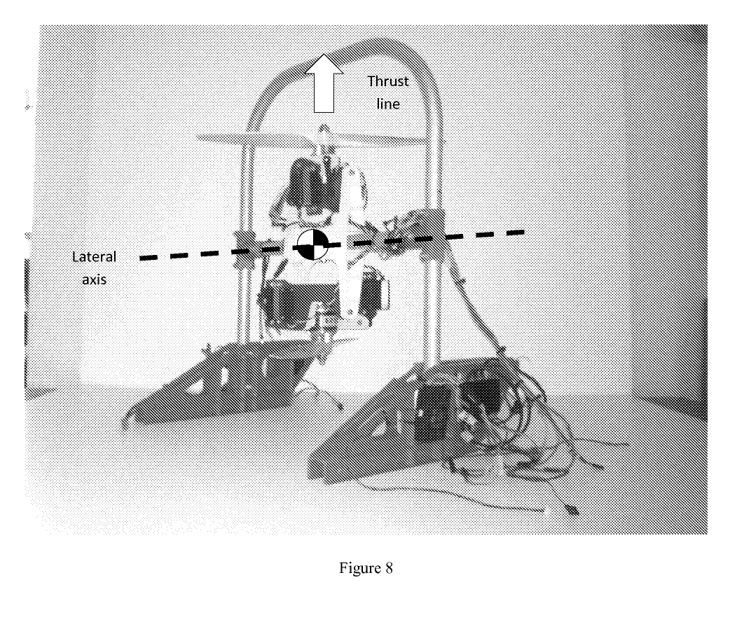

FIG. 9 shows the lateral axis in a front view on a vehicle with two in-line propulsion units

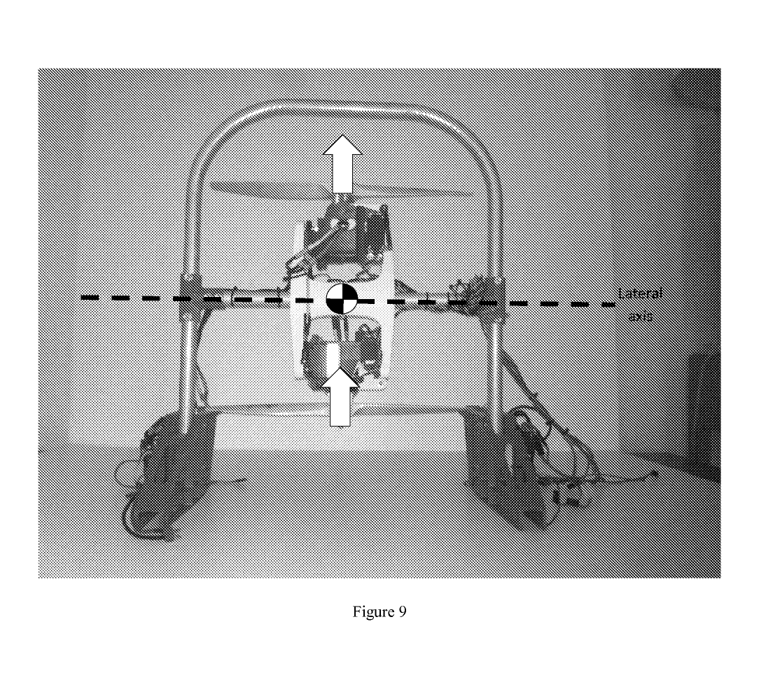

FIG. 10 shows a negative lateral force component with zero rolling moment and two in-line propulsion units

FIG. 11 shows a positive lateral force component with zero rolling moment and two in-line propulsion units

FIG. 12 shows a negative rolling moment with zero lateral force component and two in-line propulsion units

FIG. 13 shows a positive rolling moment with zero lateral force component and two in-line propulsion units

FIG. 14 shows the longitudinal axis in a side view on a vehicle with two in-line propulsion units

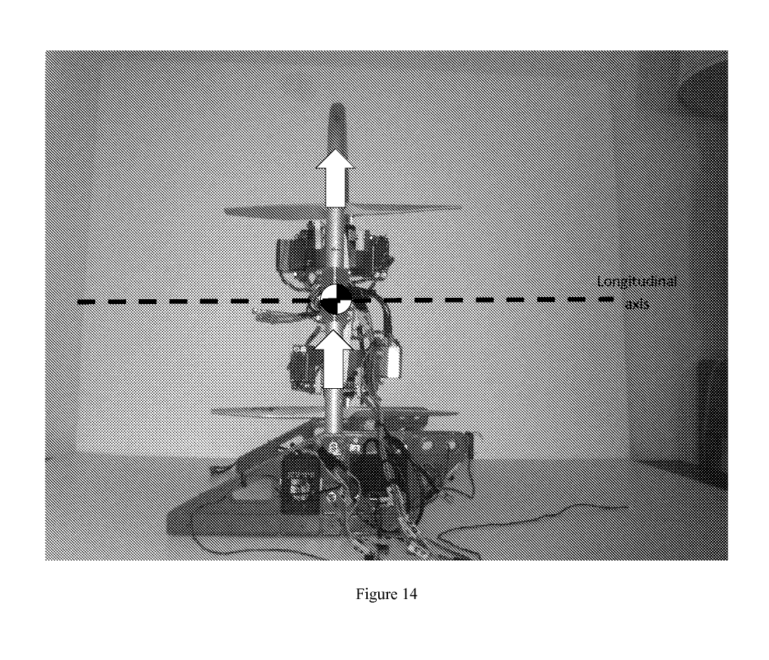

FIG. 15 shows a positive longitudinal force component with zero pitching moment and two in-line propulsion units

FIG. 16 shows a negative longitudinal force component with zero pitching moment and two in-line propulsion units

FIG. 17 shows a positive pitching moment with zero longitudinal force component and two in-line propulsion units

FIG. 18 shows a negative pitching moment with zero longitudinal force component and two in-line propulsion units

### EQUATIONS FOR THRUST, FORCES AND MOMENTS

The components (Fₜₓ, F_{ty}, F_{tz}) of the thrust vector for one propulsion unit in a coordinate system (x,y,z), with its origin at the vehicle center-of-gravity, fixed to the body of the vehicle, can be expressed as:

$$( \begin{matrix}Ftx \\ Fty \\ Ftz\end{matrix} ) = ( \begin{matrix}cos ( δ p ) & 0 & sin ( δ p ) \\ 0 & 1 & 0 \\ - sin ( δ p ) & 0 & cos ( δ p )\end{matrix} ) ( \begin{matrix}1 & 0 & 0 \\ 0 & cos ( δ r ) & - sin ( δ r ) \\ 0 & sin ( δ r ) & cos ( δ r )\end{matrix} ) ( \begin{matrix}0 \\ 0 \\ - T\end{matrix} ) \qquad [ 1 ]$$

where T is the thrust of the propulsion unit and δp and δr are the consecutive control rotations of the propulsion unit around its rotation axes in pitch and roll. Note that the above is only one example for the placement of the rotation axes. They need not be parallel to any of the body axes (x, y, z) or be perpendicular between themselves. In this example the following is obtained:

Ftx/T=−sin(δp)cos(δr) [2a]

Fty/T=sin(δr) [2b]

Ftz/T=−cos(δp)cos(δr) [2c]

These components can be used to calculate the moments (Lt, Mt, Nt) of the thrust vector around the axes ( x, y, z)

$$( \begin{matrix}Lt \\ Mt \\ Nt\end{matrix} ) = ( \begin{matrix}0 & - Zt & Yt \\ Zt & 0 & - Xt \\ - Yt & Xt & 0\end{matrix} ) ( \begin{matrix}Ftx \\ Fty \\ Ftz\end{matrix} ) \qquad [ 3 ]$$

In the above example the following is obtained:

Lt=−(Zt)(Fty)+(Yt)(Ftz)

Mt=(Zt)(Ftx)−(Xt)(Ftz)

Nt=−(Yt)(Ftx+(Xt)(Fty)

Lt/T=(−Zt)(sin(δr)−(Yt)(cos(δp)(cos(δr)) [4a]

Mt/T=(−(Zt)(sin(δp)+(Xt)(cos(δp))(cos(δr) [4b]

Nt/T=(Yt)(sin(δp))(cos(δr))+(Xt)(sin(δr)) [4c]

The transformation of the (Ftx, Fty, Ftz) in the body fixed coordinate system (x, y, z) to an earth fixed coordinate (xₑ, yₑ, zₑ) through the Euler angles ψ, θ, and φ obtained through consecutive rotation is:

$$( \begin{matrix}Ftxe \\ Ftye \\ Ftze\end{matrix} ) = ( \begin{matrix}cos ( ψ ) & - sin ( ψ ) & 0 \\ sin ( ψ ) & cos ( ψ ) & 0 \\ 0 & 0 & 1\end{matrix} ) ( \begin{matrix}cos ( θ ) & 0 & sin ( θ ) \\ 0 & 1 & 0 \\ - sin ( θ ) & 0 & cos ( θ )\end{matrix} ) ( \begin{matrix}1 & 0 & 0 \\ 0 & cos ( φ ) & - sin ( φ ) \\ 0 & sin ( φ ) & cos ( φ )\end{matrix} ) ( \begin{matrix}Ftx \\ Fty \\ Ftz\end{matrix} ) \qquad [ 6 ]$$

The choice of heading angle is arbitrary and we choose ψ=0 for continued analysis. In the above example the following is obtained:

$$\begin{matrix} ( \begin{matrix}Ftxe \\ Ftye \\ Ftze\end{matrix} ) = ( \begin{matrix}cos ( θ ) & 0 & sin ( θ ) \\ 0 & 1 & 0 \\ - sin ( θ ) & 0 & cos ( θ )\end{matrix} ) ( \begin{matrix}1 & 0 & 0 \\ 0 & cos ( φ ) & - sin ( φ ) \\ 0 & sin ( φ ) & cos ( φ )\end{matrix} ) ( \begin{matrix}Ftx \\ Fty \\ Ftz\end{matrix} ) \\ ( \begin{matrix}Ftxe \\ Ftye \\ Ftze\end{matrix} ) = ( \begin{matrix}cos ( θ ) & 0 & sin ( θ ) \\ 0 & 1 & 0 \\ - sin ( θ ) & 0 & cos ( θ )\end{matrix} ) ( \begin{matrix}Ftx \\ cos ( φ ) ( Fty ) - sin ( φ ) ( Ftz ) \\ sin ( φ ) ( Fty ) + cos ( φ ) ( Ftz )\end{matrix} ) \\ ( \begin{matrix}Ftxe \\ Ftye \\ Ftze\end{matrix} ) = ( \begin{matrix}cos ( θ ) ( Ftx ) + sin ( θ ) ( sin ( θ ) Fty + cos ( φ ) ( Ftz ) ) \\ cos ( φ ) ( Fty ) - sin ( φ ) ( Ftz ) \\ - sin ( θ ) ( Ftx ) + cos ( θ ) ( sin ( φ ) ( Fty ) + cos ( φ ) ( Ftz ) )\end{matrix} ) & [ 7 ] \\ Ftxe \text{/} T = - cos ( θ ) sin ( δ p ) cos ( δ r ) + sin ( θ ) ( sin ( φ ) sin ( δ r ) - cos ( δ p ) cos ( δ r ) ) & [ 8 a ] \\ Ftye \text{/} T = cos ( φ ) sin ( δr ) + sin ( φ ) cos ( δ p ) cos ( δ r ) & [ 8 b ] \\ Ftze \text{/} T = sin ( θ ) cos ( δ p ) cos ( δ r ) + cos ( θ ) ( sin ( φ ) sin ( δ r ) - cos ( φ ) cos ( δ p ) cos ( δ r ) ) & [ 8 c ]\end{matrix}$$

### Control of Vehicle Attitude with Two Propulsion Units

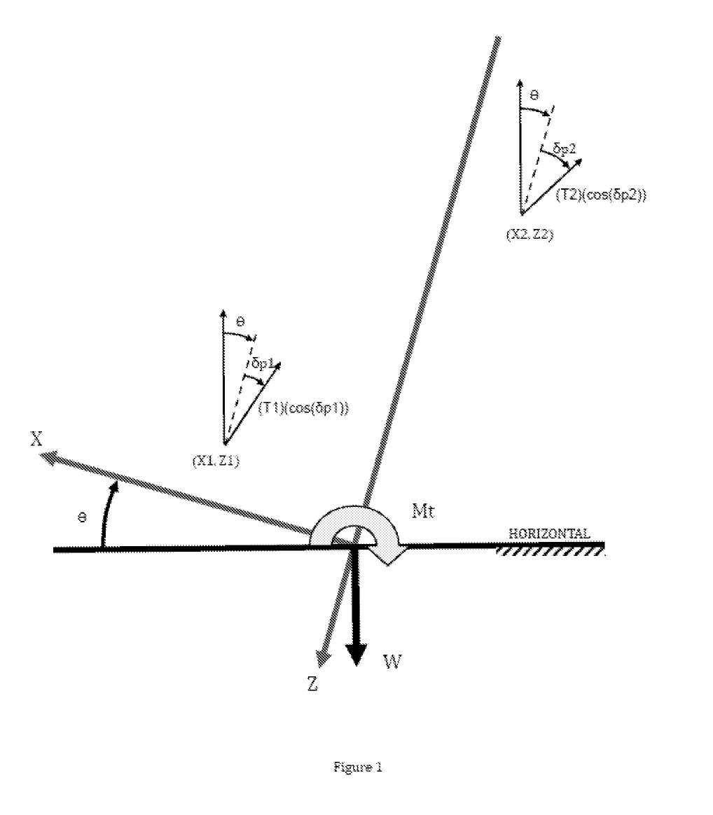

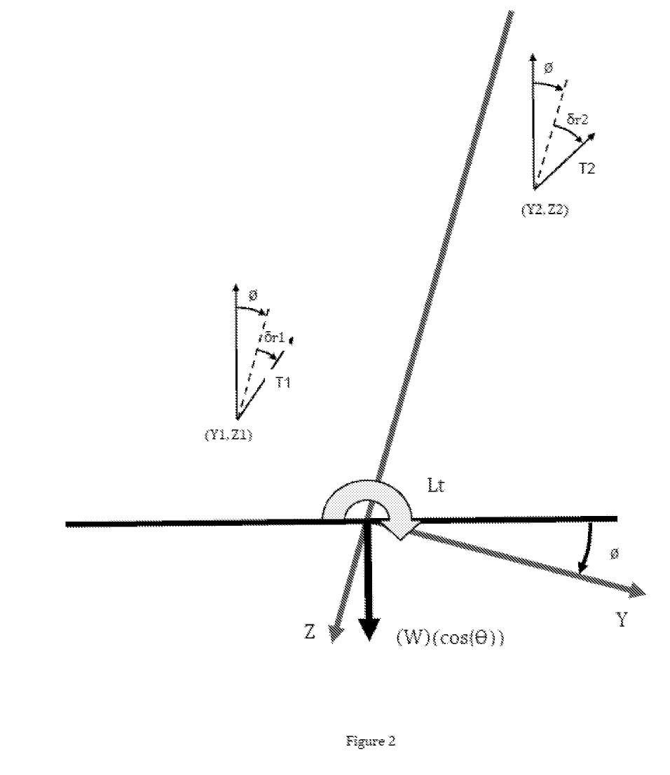

Reference: FIGS. 1 and 2.

Both the lower and upper propulsion units are deflected together such as to give zero net force in the x and y directions of the body fixed coordinate system. Equations (2) then give

Ftx=−(T1)(sin(δp1)cos(δr1))−(T2)(sin(δp2)cos(δr2))=0

Fty=(T1)(sin(δr1))+(T2)(sin(δr2))=0

or

sin(δp1)cos(δr1)=−(T2/T1)(sin(δp2)cos(δr2)) [9a]

sin(δr1)=−(T2/T2)(sin(δr2)) [9b]

It is assumed that the thrust values T1 and T2 can be calculated, for example, from parameters such as throttle position, RPM and so on. For particular control inputs δp2, δr2 to the upper propulsion unit then the control defletions δp1, δr1 for the lower unit can be calculated from equations (9) above to yield moments around the center-of-gravity of the vehicle without attendant force in the xy-plane of the body fixed coordinate system.

The method of control described above lends itself to control the vehicle attitude to given or desired values of pitch angle θ and roll angle φ through the use of an automatic feedback control system. Such a system can be expected to hold the attitude of the vehicle close to desired values. If these values are chosen to be θ=φ=0 then the resulting forces in horizontal plane per equations (8) will be small.

It is assumed that the two propulsion units are counter rotating to cancel out the propulsion torque. It is then possible to control the heading, in the horizontal plane, by varying the trust or rpm for the two units to give a differential torque. The incurred difference in thrust between the two units is accounted for in equations (9) above. Control of attitude around ALL three axes is thus attained.

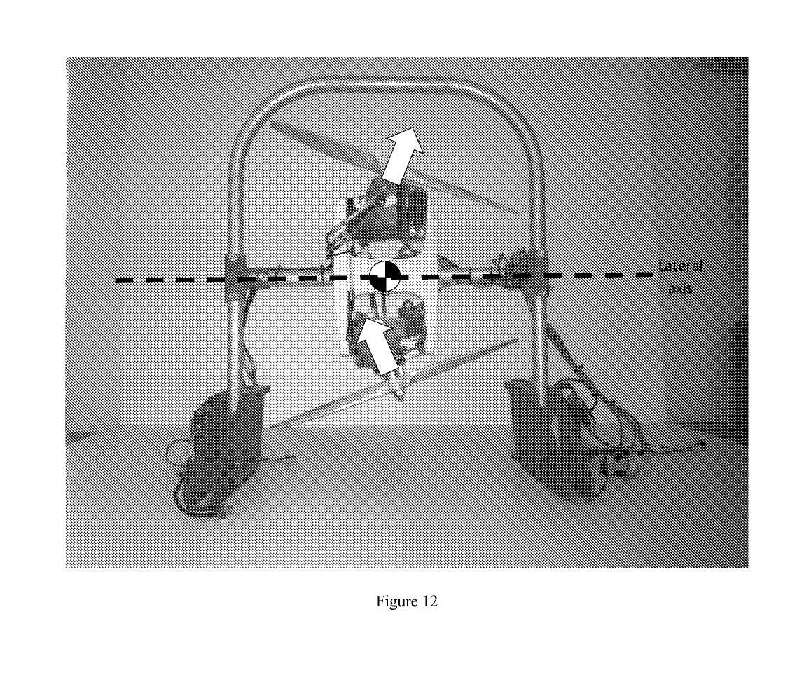

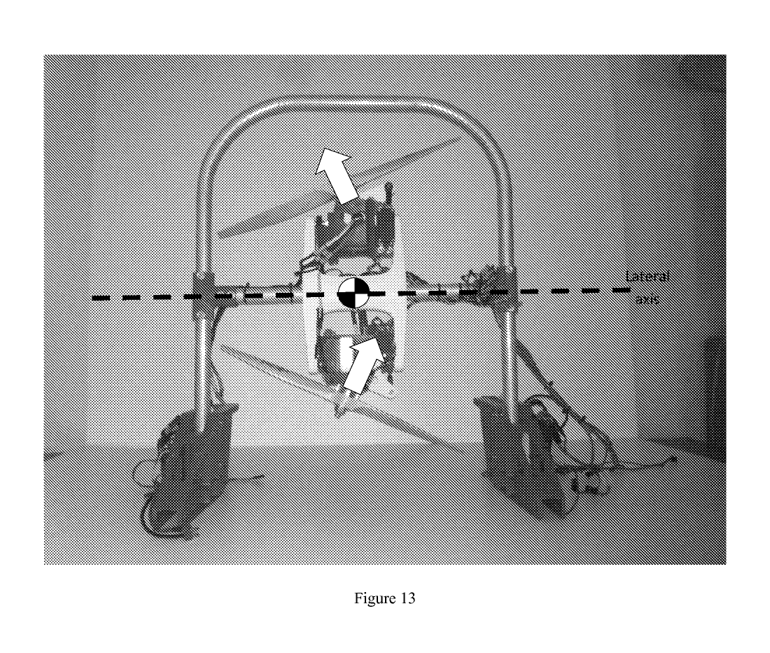

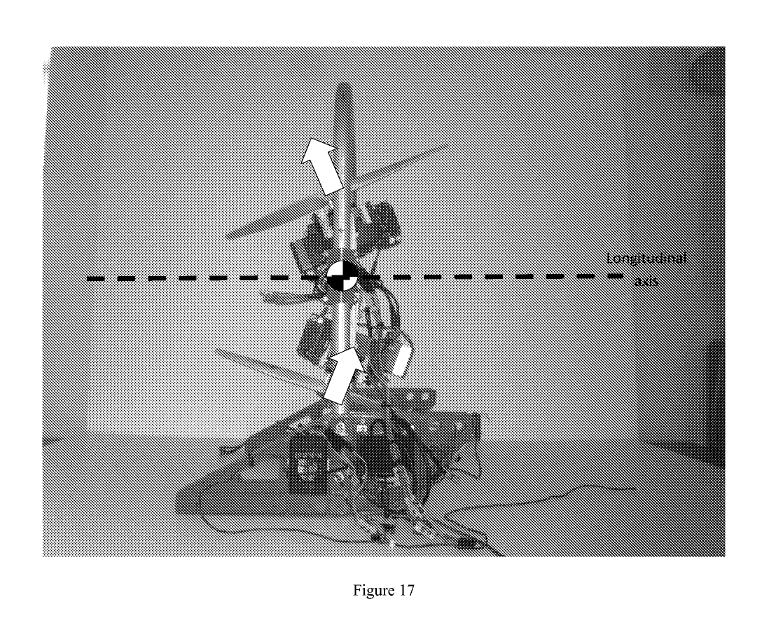

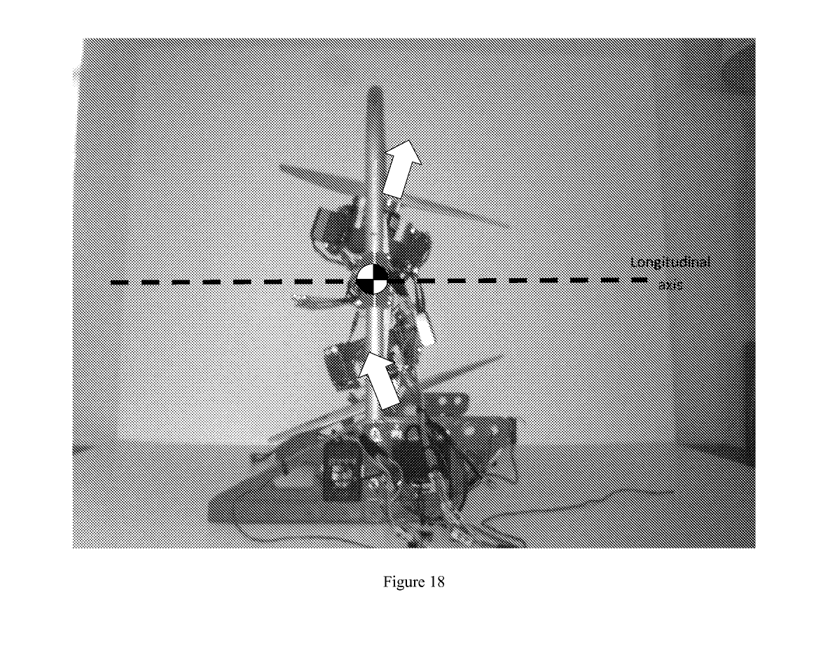

FIGS. 12 and 13 exemplifies the attitude control around the longitudinal or roll axis, while FIGS. 17 and 18 illustrates attitude control around the lateral or pitch axis.

### Control of Vehicle Position with Two Propulsion Units

Reference: FIGS. 1 and 2.

A deflection of the lower propulsion unit will create a lateral force but may also cause an undesirable moment around the center-of-gravity of the vehicle, see FIG. 1. The upper propulsion unit is therefore deflected to counter that moment to give a total net moment equal to zero.

Equations (4) give:

Lt=−(T1)((Y1)(cos(δp1)cos(δr1))+(Z1)(sin(δr1)))−(T2)((Y2)(cos(δp2)cos(δr2))+(Z2)(sin(δr2)))

Mt=(T1)((X1)(cos(δp1))−(Z1)(sin(δp1)cos(δr1)))+(T2)((X2)(cos(δp2))−(Z2)(sin(δp2)cos(δr2)))

or

(Y2)(cos(δp2)cos(δr2))+(Z2)(sin(δr2))=−(T1/T2)((Y1)(cos(δp1)cos(δr1))+(Z1)(sin(δr1))) [10a]

(X2(cos(δp2))−Z2(sin(δp2)))(cos(δr2))=−(T1/T2)(X1(cos(δp1))−Z1(sin(δp1)))(cos(δr1)) [10b]

The geometry values (X1, Y1, Z1) and (X2, Y2, Z2) are assumed known.

It is also assumed that the thrust values T1 and T2 can be calculated, for example, from parameters such as trottle position, RPM and so on. For particular control inputs δp1, δr1 to the lower propulsion unit then the control deflections δp2, δr2 for the upper unit can be calculated from equations (10a), (10b) above to yield lateral forces without attendant moment around the center-of-gravity of the vehicle. Control of the vertical position of the vehicle is obtained through changing the thrust of both propulsion units. Control of vehicle position along ALL three axes is thus attained.

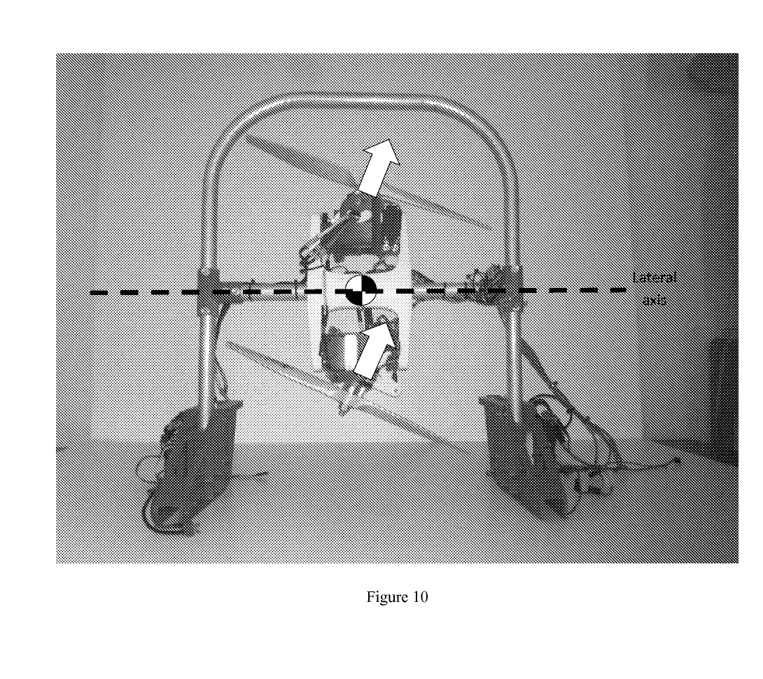

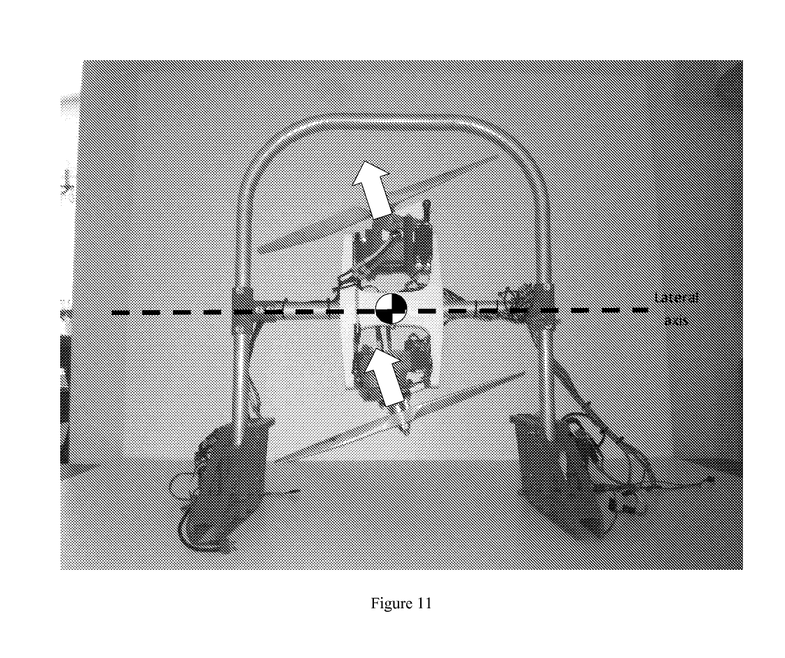

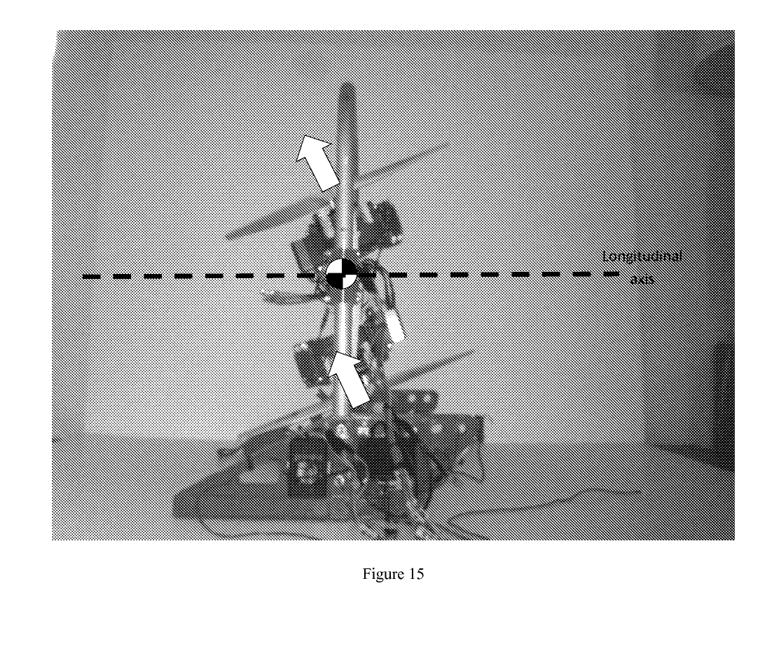

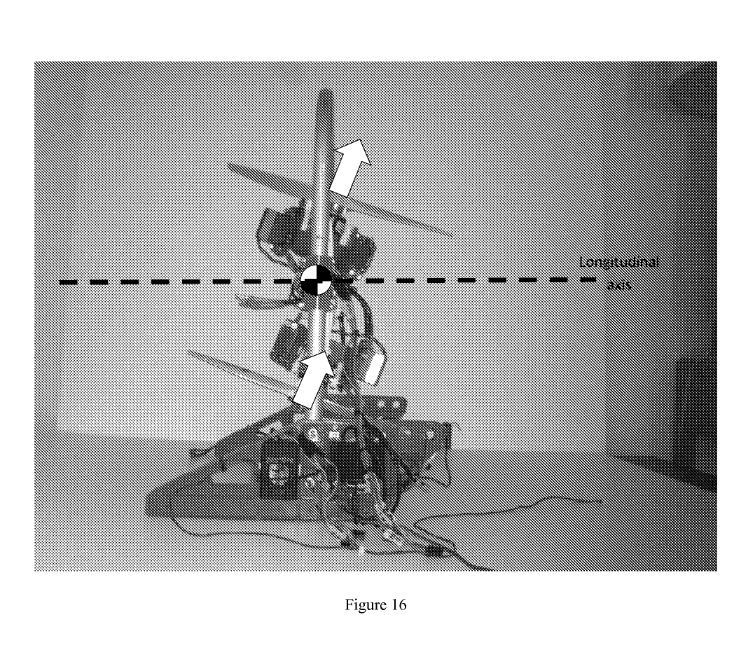

FIGS. 10 and 11 exemplifies the position control in the lateral direction, while FIGS. 15 and 16 illustrates position control in the longitudinal direction.

### Control with Three Propulsion Units

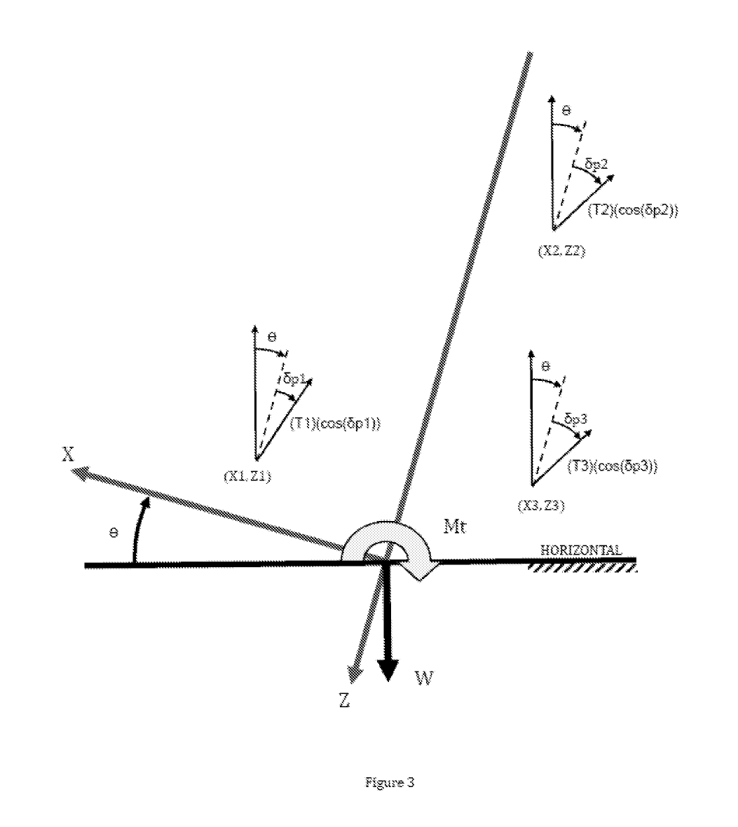

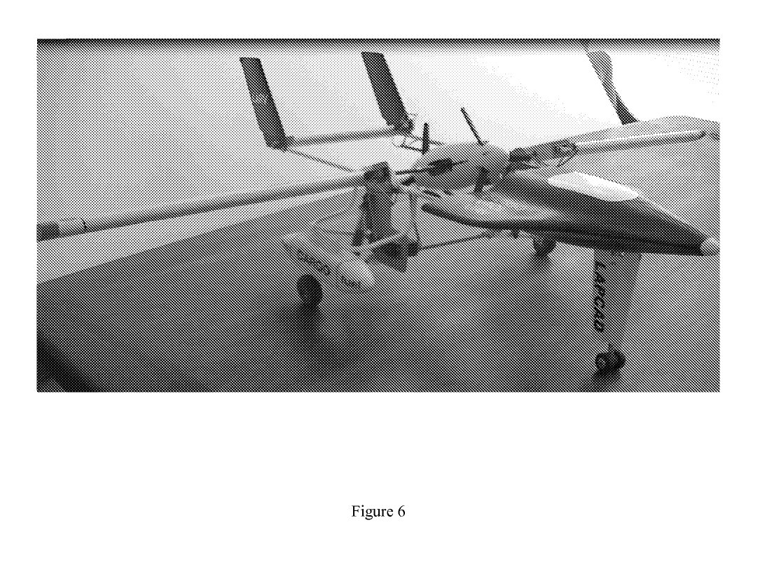

Reference: FIGS. 3 to 6

An arrangement with propulsion units has the following advantages over two units placed in tandem depending on control authority and design:
a) Control of heading through varying the direction of thrust instead of using differential torque
b) Capability to control a malfunctioning propulsion unit

All three propulsion units are deflected together such as to give zero net force along the x and y directions of the body fixed coordinate system to control vehicle attitude in pith and roll. Equations (2) then give:

Ftx=−Σₙ₌₁³(Tn)(sin(δpn))(cos(δrn))=0 [11]

Fty=Σₙ₌₁³(Tn)(sin(δrn))=0 [12]

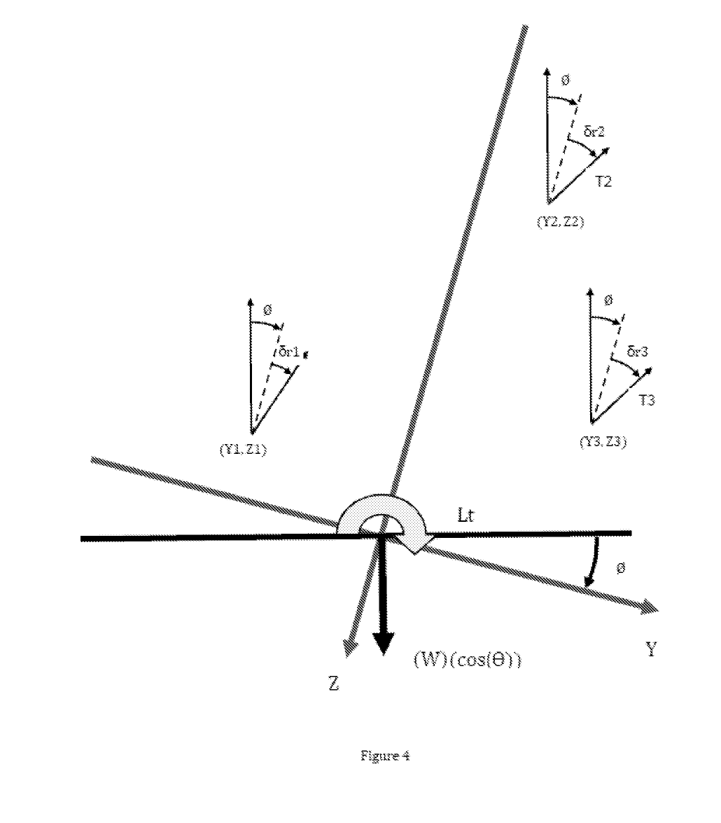

Control of the vehicle attitude around the x-axis (the roll axis) is illustrated in FIG. 4. The deflection of propulsion unit 2 is considered a control input, δr2

Equation (12) then gives:

(T1)(sin(δr1))+(T3)(sin(δr3))=−(T2)(sin(δr2)) [13]

If, for example, δr3 is set equal to δr1, then equation (13) gives:

sin(δr1)=sin(δr3)=−(T2/(T1+T3)) (sin(δr2)) [14]

It is assumed that the thrust values T1, T2 and T3 can be determined Equation (14) then gives the values δr1 and δr3 which propulation units 1 and 3 need to be deflected given the control input δr2 and the thrust values to yield a rolling moment around the x-axis without attendent force Fty.

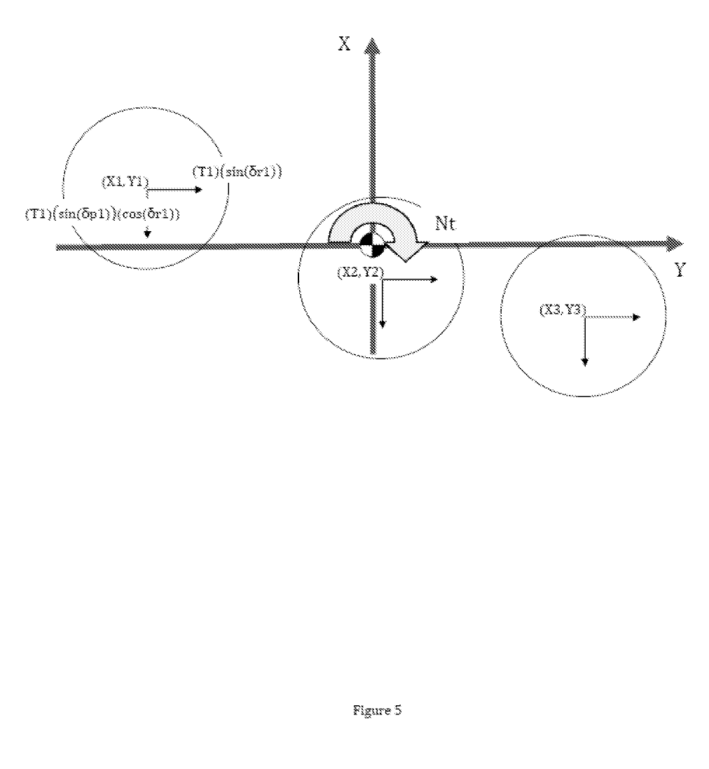

Control of the vehicle attitude around the y-axis (the pitch axis) is shown in FIG. 3. The deflection of propulsion unit 2 is considered a control input, δp2. The corresponding deflection δpp1 and εpp3 of propulsion units 1 and 3 are to be determined. In addition, propulsion units 1 and 3 are deflected in opposite directions, δpy1 and δpy3, for control of the vehicle attitude around the z-axis (the yaw axis), see FIG. 5. The deflections δpy1 and δpy3 are considered known control inputs.

If, for example, δpp3 is set equal to δpp1 and δpy3 is set equal to −δpy1, then equation (11) gives:

(T1)(sin(δpp1+δpy1))(cos(δr1))+(T3)(sin(δpp1−δpy1))(cos(δr3))=−(T2)(sin(δp2))(cos(δr2)) [15]

With thrust values T1, T2 and T3 known, then δpp1=δpp3 can be determined from equation (15).

To illustrate, as one example, assume that T1=T2=T3,

and that δr3 is set equal to δr1, as in the example above, then equation (15)becomes:

(sin(δpp1))(cos(δpy1))+(cos(δpp1))(sin(δpy1))+(sin(δpp1))(cosδpy1))−(cos(δpp1))(sin(δpy1))=−(sin(δp2))(cos(δr2))/(cos(δr1))

or

sin(δpp1)=−((½)(sin(δp2))(cos(δr2))/(cos(δr1)))/(cos(δpy1)) [16]

The deflections δp2 and δr2 are given control inputs. The deflections δr1=δr3 are given by equation (14). The deflections δpy1=−δpy3 are also given control inputs. The desired deflections δpp1=δpp3 can then be determined from equation (16) under the above assumptions. This yields moments around all three body axes to control the vehicle attitude without attendent forces Ftx and Fty.

All three propulsion units are deflected together in such a manner as to give zero moment around all three axes in the body fixed coordinate system, in order to control the vehicle sideways position.

Equations (4) then give:

Xtn=−Σₙ₌₁³(Tn)((Zn)(sin(δrn))+(Yn)(cos(δpn(cos(δrn)))=0 [17]

Ytn=Σₙ₌₁³(Tn)(−(Zn)(sin(δpn))+(Xn)(cos(δpn)cos(δrn)))=0 [18]

Ztn=Σₙ₌₁³(Tn)((Yn)(sin(δpn))(cos(δrn))+(Xn)(sin(δrn)))=0 [19]

As an example, assume that the vehicle attitude angles θ and φ are controlled to values close to zero as described above. The forces Ftx and Fty can then be used to control the vehicle lateral position. It is desirable to keep the moments close to zero per equations (17) through (19) during such position control.

To illustrate, as an example, consider the lateral force Fty with the requirement that Lt=0 per equation (17). Also assume that T1=T2=T3 and that the deflections of propulsion units 1 and 3, denoted δr1 and δr3 are known control inputs and that they are made equal, i.e. δr1=δr3. For clarity, assume symmetry such that Y1=−Y3 and Y2=0 in FIG. 4. Equation (17) then gives:

(Z1)(sin(δr1))+(y1)(cos(δp1))(cos(δr1))+(Z3)(sin(δr1))−(Y1)(cos(δp3))(cos(δr1))+(Z2)(sin(δr2)=0

or

$$sin ( δ r 2 ) = - ( \frac{Z 1 + Z 3}{Z 2} ) ( sin ( δ r 1 ) ) - ( \frac{Y 1}{Z 2} ) ( cos ( δ r 1 ) ) ( cos ( δ p 1 ) - cos ( δ p 3 ) ) \qquad [ 20 ]$$

δp1 and δp3 are here also assumed known control inputs for the force Ftx. The geometry is known. The desired deflection angle for propulsion unit 2 is thus given by equation (20).

The treatment of the longitudinal force Ftx with Mt=0 and Nt=0 is similar.

Altitude is controlled with thrust on the three propulsion units such as to give zero moment.

Control of the vehicle position is thus achieved without incurring attendant moments around the vehicle center-of-gravity.

I claim:

1. A method to control a flight vehicle during vertical flight and landing as illustrated with two in-line counter-rotating propulsion units by making each unit
individually rotatable around both a lateral axis and a longitudinal axis such that when the thrust of the propulsion units is primarily vertical:
individual rotation of each propulsion unit around the lateral axis with a control system is accomplished in such a manner to obtain
either
a moment around the lateral axis through the center-of-gravity of the vehicle to pitch the vehicle around the said lateral axis without attendant net force component along the longitudinal axis
or
a net force component along the longitudinal axis to move the vehicle without attendant moment around the lateral axis through the center-of-gravity of the vehicle
or
a desired combination of moment and net force component
and
individual rotation of each propulsion unit around the longitudinal axis with a control system is accomplished in such a manner to obtain
either
a moment around the longitudinal axis through the center-of-gravity of the vehicle to roll the vehicle around the said longitudinal axis without attendant net force component along the lateral axis
or
a net force component along the lateral axis to move the vehicle without attendant moment around the longitudinal axis through the center-of-gravity of the vehicle
or
a desired combination of moment and net force component

2. The method of claim 1, a flight vehicle during vertical flight and landing as illustrated on a vehicle
with a propulsion system comprising two in-line counter-rotating propulsion units,
where the whole propulsion system is rotatable around a lateral axis by making one of the two propulsion units individually rotatable around a lateral axis and both propulsion units individually rotatable around a longitudinal axis such that when the thrust is primarily vertical: rotation of the whole propulsion system around the lateral axis and rotation of the one individually rotatable propulsion unit around the lateral axis is accomplished through a control system in such a manner to obtain either a moment around the lateral axis through the center-of-gravity of the vehicle to pitch the vehicle around the said lateral axis without attendant net force component along the longitudinal axis
or
a net force component along the longitudinal axis to move the vehicle without attendant moment around the lateral axis through the center-of-gravity of the vehicle
or
a desired combination of moment and net force component
and
individual rotation of each propulsion assembly around the longitudinal axis with a control system is accomplished in such a manner to obtain
either
a moment around the longitudinal axis through the center-of-gravity of the vehicle to roll the vehicle around the said longitudinal axis without attendant net force component along the lateral axis
or
a net force component along the lateral axis to move the vehicle without attendant moment around the longitudinal axis through the center-of-gravity of the vehicle
or
a desired combination of moment and net force component
